(19) United States
(12) Patent Application Publication
(10) Pub. No.: US 2014/0280600 A1
(43) Pub. Date: Sep. 18, 2014

(54) MEETING ARRANGEMENT SYSTEM BETWEEN MEMBERS OF WEBSITE AND APPLICATION

(71) Applicant: Seung Hun Jeon, Daejeon (KR)

(72) Inventor: Seung Hun Jeon, Daejeon (KR)

(21) Appl. No.: 14/352,999

(22) PCT Filed: Oct. 16, 2013
(86) PCT No.: PCT/KR2013/009223

§ 371 Date: Apr. 18, 2014

(30) Foreign Application Priority Data
Nov. 27, 2012 (KR) 10-2012-0135295

(51) Int. Cl. H04L 29/08

(52) U.S. Cl. CPC H04L 67/306
USPC 709/204

(57) ABSTRACT

The invention relates to a meeting arrangement system between members of a website and an application, and more particularly, to a meeting arrangement system between members of a website and an application capable of arranging the meeting between the members through the online site by using the interne website or the application program.

### TECHNICAL FIELD

The invention relates to a meeting arrangement system between members of a website and an application, and more particularly, to a meeting arrangement system between members of a website and an application capable of arranging the meeting between the members through the online site by using the internet website or the application program.

### BACKGROUND ART

Since the meeting of the opposite sex or the new friend is achieved in his environment, it is difficult to have a new opportunity for oneself as the time and the space are limited to the task.

It talks with or gets accomplished with the unknown opponent through the communication medium such as the telephone or the internet. However, since it is necessary to have many hours and procedures for the accordance and confidence of the mutual opinion, it is not helpful to the busy people.

In conclusion, the opportunity of the direct new relationship between humans is arisen through a matchmaking or a particular event. There is no special means excepting the above conventional methods.

For this reason, the most important meeting of the opposite sex is provided by the conventional matchmaking, introduction or event and so on. Recently, the meeting arrangement has been activated through the broadcast media and the internet.

However, where the meeting arrangement is accomplished by the internet, the other party can register his profile falsely. Also, there may be a violence or a sexuality.

Moreover, in case of the existing meeting site, the personal information of the plural male members or female members is provided to the specific member and the specific member selects the desiring member.

Therefore, there is an unfair side in that the personal information of the members is exposed to one side.

### DISCLOSURE

### Technical Problem

Accordingly, the present invention has been made to solve the above-mentioned problems occurring in the prior art, and a object of the present invention is to provide a meeting arrangement system between members of a website and an application in that it executes the meeting arrangement site or application, so that the member signs up for a membership, an access approval procedure is completed through an approval examination process of the administrator, and the meeting arrangement is matched to the user, to whom the access is approved, in order of matching success probability with reference to the inputted personal information and the current connection position information.

Another object of the present invention is to provide a meeting arrangement system between members of a website and an application in that it determines matching success by expressing the good feeling with an opponent in a fixed time, thereby offering a private contact information when the matching succeeds and providing chatting or message functions.

### Technical Solution

In order to accomplish this object, there is provided a meeting arrangement system between members of a website and an application comprising: a meeting arrangement server 100 comprising a matching member registration unit 150 having a meeting arrangement application providing unit 151 for providing a meeting arrangement application to a member client 200, a member registration unit 152 for joining for a membership by acquiring a basic personal information and a profile information from the member client, which is equipped with the meeting arrangement application provided by the meeting arrangement application providing unit or connects to the website, an photo information registration unit 153 for extracting a photo information among the acquired profile information and storing it in a photo information DB; a member information registration unit 154 for storing the acquired basic personal information and profile information in a member information DB, the photo information database 155 for storing the photo information handled at the photo information registration unit therein, the member information database 156 for storing the basic personal information and profile information handled at the member information registration unit; an evaluation information transmission unit 157 for transmitting the information stored in the photo information database 155 and the member information database 156 to an access approving evaluation terminal, an approval evaluation pass information obtainment unit 158 for obtaining an approval evaluation pass information from the approving evaluation terminal, and a pass member information transmission unit 159 for transmitting the basic personal information and photo information of the member, who passes the approval evaluation, to the member matching unit; and the member matching unit 180 having a matching basic information storage processing unit 181 for acquiring the information transmitted from the pass member information transmission unit 159, extracting a sex, a residential area, a preference area, an age, and an ideal type information, and storing them in a matching basic information database, the matching basic information database 182 for storing the information handled at the matching basic information storage processing unit 181 therein, a current connection position extraction unit 183 for extracting a current connection position of the member stored in the matching basic information database 182, a matching member recommendation unit 184 for recommending female members to male members or male members to female members with reference to the information extracted from the matching basic information database 182 and the current connection position extraction unit 183, a detail personal information providing unit 185 for providing a detail personal information, which does not include a contact information of the opponent member of the opposite sex, to the member recommended by the matching member recommendation unit 184, a good feeling display message obtainment unit 186 for obtaining a good feeling display message from the client terminal of the member of the opposite sex, a contact information providing unit 187 for determining whether the good feeling display messages are generated by all members of the opposite sex through the good feeling display message obtainment unit 186 or not and providing the contact information of the opponent member of the opposite sex when the good feeling display messages are received from all members of the opposite sex, a message receiving time counting unit 188 for counting the receiving time of the good feeling display messages, and a new opposite sex member recommendation unit 189 by determining whether the good feeling display message is transmitted to the opponent member of the opposite sex by means of the good feeling display message obtainment unit 186 from the time of providing the detail personal information to the opponent member of the opposite sex in the detail personal information providing unit 185 to the designated time or not and then, recommending a new opposite sex member when the good feeling display message is not obtained within the appointed time; a member client 200 for executing the meeting arrangement application provided by the meeting arrangement server 100 or connecting to the website so as to provide the basic personal information, the profile information, and the current position information to the meeting arrangement server 100; and the access approving evaluation terminal 300 for acquiring the member information and the photo information provided by the arrangement server 100 and providing the approval evaluation pass information to the arrangement server 100, wherein the contact information providing unit 187 comprises an item providing unit (not shown) for providing items for performing the corresponding functions during the good feeling expression, the message and chatting progress, the good feeling score confirmation, the self recommendation, the look-alike recommendation, the public request, and the recommendation of the past recommendation figure.

### Advantageous Effects

According to the meeting arrangement system between members of the website and the application of the present invention, there is an effect in that it executes the meeting arrangement site or application, so that the member signs up for a membership, an access approval procedure is completed through an approval examination process of the administrator, and the meeting arrangement is matched to the user, to whom the access is approved, in order of matching success probability with reference to the inputted personal information and the current connection position information.

Also, there is another effect in that it determines matching success by expressing the good feeling with the opponent in a fixed time, thereby offering the private contact information when the matching succeeds and providing chatting or message functions.

### BRIEF DESCRIPTION OF THE DRAWINGS

The above and other objects, features and advantages of the present invention will be more apparent from the following detailed description taken in conjunction with the accompanying drawings, in which:

FIG. 1 is an entire block diagram illustrating a meeting arrangement system between members of a website and an application according to a preferred embodiment of the present invention;

FIG. 2 is a block diagram illustrating a meeting arrangement server of a meeting arrangement system between members of a website and an application according to a preferred embodiment of the present invention;

FIG. 3 is a block diagram illustrating a matching member recommendation unit of a meeting arrangement system between members of a website and an application according to a preferred embodiment of the present invention;

FIG. 4 is an example view illustrating a screen during member joining in a meeting arrangement system between members of a website and an application according to a preferred embodiment of the present invention;

FIG. 5 is an example view illustrating an example of providing a recommendation opposite sex information in a meeting arrangement system between members of a website and an application according to a preferred embodiment of the present invention;

FIG. 6 is an example view illustrating an item purchase ticket of a meeting arrangement system between members of a website and an application according to a preferred embodiment of the present invention;

FIG. 7 is an example view illustrating a charm certificate screen of a meeting arrangement system between members of a website and an application according to a preferred embodiment of the present invention; and

FIG. 8 is an example view illustrating a screen of providing the past relationship of a meeting arrangement system between members of a website and an application according to a preferred embodiment of the present invention.

### DESCRIPTIONS ON REFERENCE NUMBERS FOR THE MAJOR COMPONENTS IN THE DRAWINGS

100: Meeting arrangement server
200: Member client
300: Access approving evaluation terminal

### Best Mode

### Mode for Invention

In order to accomplish this object, there is provided a meeting arrangement system between members of a website and an application comprising: a meeting arrangement server 100 comprising a matching member registration unit 150 having a meeting arrangement application providing unit 151 for providing a meeting arrangement application to a member client 200, a member registration unit 152 for joining for a membership by acquiring a basic personal information and a profile information from the member client, which is equipped with the meeting arrangement application provided by the meeting arrangement application providing unit or connects to the website, an photo information registration unit 153 for extracting a photo information among the acquired profile information and storing it in a photo information DB; a member information registration unit 154 for storing the acquired basic personal information and profile information in a member information DB, the photo information database 155 for storing the photo information handled at the photo information registration unit therein, the member information database 156 for storing the basic personal information and profile information handled at the member information registration unit; an evaluation information transmission unit 157 for transmitting the information stored in the photo information database 155 and the member information database 156 to an access approving evaluation terminal, an approval evaluation pass information obtainment unit 158 for obtaining an approval evaluation pass information from the approving evaluation terminal, and a pass member information transmission unit 159 for transmitting the basic personal information and photo information of the member, who passes the approval evaluation, to the member matching unit; and the member matching unit 180 having a matching basic information storage processing unit 181 for acquiring the information transmitted from the pass member information transmission unit 159, extracting a sex, a residential area, a preference area, an age, and an ideal type information, and storing them in a matching basic information database, the matching basic information database 182 for storing the information handled at the matching basic information storage processing unit 181 therein, a current connection position extraction unit 183 for extracting a current connection position of the member stored in the matching basic information database 182, a matching member recommendation unit 184 for recommending female members to male members or male members to female members with reference to the information extracted from the matching basic information database 182 and the current connection position extraction unit 183, a detail personal information providing unit 185 for providing a detail personal information, which does not include a contact information of the opponent member of the opposite sex, to the member recommended by the matching member recommendation unit 184, a good feeling display message obtainment unit 186 for obtaining a good feeling display message from the client terminal of the member of the opposite sex, a contact information providing unit 187 for determining whether the good feeling display messages are generated by all members of the opposite sex through the good feeling display message obtainment unit 186 or not and providing the contact information of the opponent member of the opposite sex when the good feeling display messages are received from all members of the opposite sex, a message receiving time counting unit 188 for counting the receiving time of the good feeling display messages, and a new opposite sex member recommendation unit 189 by determining whether the good feeling display message is transmitted to the opponent member of the opposite sex by means of the good feeling display message obtainment unit 186 from the time of providing the detail personal information to the opponent member of the opposite sex in the detail personal information providing unit 185 to the designated time or not and then, recommending a new opposite sex member when the good feeling display message is not obtained within the appointed time; a member client 200 for executing the meeting arrangement application provided by the meeting arrangement server 100 or connecting to the website so as to provide the basic personal information, the profile information, and the current position information to the meeting arrangement server 100; and the access approving evaluation terminal 300 for acquiring the member information and the photo information provided by the arrangement server 100 and providing the approval evaluation pass information to the arrangement server 100, wherein the contact information providing unit 187 comprises an item providing unit (not shown) for providing items for performing the corresponding functions during the good feeling expression, the message and chatting progress, the good feeling score confirmation, the self recommendation, the look-alike recommendation, the public request, and the recommendation of the past recommendation figure.

Here, the meeting arrangement server 100 further includes an information sharing providing unit for providing a message or a chatting function to the matched male member and the matched female member so as to execute any program capable of sharing the real-time information with the matched members.

Here, the matching member recommendation unit 184 recommends the opponent sex member with reference to a nationality, a residential nation, a residential area, a connection area, a preference area, a religion, an age, and an ideal type information in case of recommending the opposite sex member.

Here, the matching member recommendation unit 184 does not recommend the opposite sex member recommended in the past until the fixed period is passed or the new opposite sex member until the fixed recommendation count is exceeded in case of the recommendation of the new opposite sex member.

Here, the meeting arrangement server 100 further includes a scoring table providing unit for providing the scoring table for evaluating the good feeling as a score after the private personal information of the recommended opposite sex member is checked out.

Here, the meeting arrangement server 100 further includes a good feeling score providing unit for providing a view of an individual good feeling score of the corresponding member assigned by the recommended opposite sex members, a view of a good feeling average score of the corresponding member assigned by the recommended opposite sex members, and an information for comparing the good feeling average score of the corresponding member with the good feeling average scores of the same sex members.

Here, the matching member recommendation unit 184 includes a self recommendation module 184a for providing an information capable of selecting the opposite sex members whom the corresponding member wants to be recommended in case of recommending the opposite sex member and a member filtering module 184b for filtering upper members within the fixed higher rank in terms of the number of the good feeling expression and the good feeling score assigned by the opposite sex members in case of selecting the desiring opposite sex members whom the corresponding member wants to be recommended.

Here, the matching member recommendation unit 184 includes a public matching selection module 184f for providing an information for a public matching request in case of recommending the opposite sex member and a public recommendation module 184g for recommending the corresponding member to the entire opposite sex members in case of passing the examination of the access approving evaluation terminal when it acquires the public matching request information.

Here, the matching member recommendation unit 184 includes a re-recommendation module 184h for recommending the past recommendation member list information, which does not match and connect thereto while recommending the new opposite sex member, where the designated time for the good feeling expression is passed.

Here, the matching member recommendation unit 184 includes a specific language providing module 184i for providing a screen displayed as the language of the corresponding nation based on the location information thereof in case of connecting to the website or executing the application program and providing a screen displayed as the corresponding language in case of selecting the supportive language.

Here, the matching member recommendation unit 184 recommends the members of the opposite sex by using only the matching basic information database.

Hereinafter, an exemplary embodiment of the present invention will be described in detail with reference to the accompanying drawings.

FIG. 1 is an entire block diagram illustrating a meeting arrangement system between members of a website and an application according to a preferred embodiment of the present invention.

As shown in FIG. 1, the meeting arrangement system between members of the website and the application includes: a meeting arrangement server 100 including a matching member registration unit 150 having a meeting arrangement application providing unit 151 for providing a meeting arrangement application to a member client 200; a member registration unit 152 for joining for a membership by acquiring a basic personal information and a profile information from the member client, which is equipped with the meeting arrangement application provided by the meeting arrangement application providing unit or connects to the website; an photo information registration unit 153 for extracting a photo information among the acquired profile information and storing it in a photo information database; a member information registration unit 154 for storing the acquired basic personal information and profile information in a member information database; the photo information database 155 for storing the photo information handled at the photo information registration unit therein; the member information database 156 for storing the basic personal information and profile information handled at the member information registration unit; an evaluation information transmission unit 157 for transmitting the information stored in the photo information database 155 and the member information database 156 to an access approving evaluation terminal; an approval evaluation pass information obtainment unit 158 for obtaining an approval evaluation pass information from the access approving evaluation terminal; and a pass member information transmission unit 159 for transmitting the basic personal information and photo information of the member, who passes the approval evaluation, to the member matching unit; and the member matching unit 180 having a matching basic information storage processing unit 181 for acquiring the information transmitted from the pass member information transmission unit 159, extracting a sex, a residential area, a preference area, an age, and an ideal type information, and storing them in a matching basic information database; the matching basic information database 182 for storing the information handled at the matching basic information storage processing unit 181 therein; a current connection position extraction unit 183 for extracting a current connection position of the member stored in the matching basic information database 182; a matching member recommendation unit 184 for recommending female members to male members or male members to female members with reference to the information extracted from the matching basic information database 182 and the current connection position extraction unit 183; a detail personal information providing unit 185 for providing a detail personal information, which does not include a contact information of the opponent member of the opposite sex, to the member recommended by the matching member recommendation unit 184; a good feeling display message obtainment unit 186 for obtaining a good feeling display message from the client terminal of the member of the opposite sex; a contact information providing unit 187 for determining whether the good feeling display messages are generated by all members of the opposite sex through the good feeling display message obtainment unit 186 or not and providing the contact information of the opponent member of the opposite sex when the good feeling display messages are received from all members of the opposite sex; a message receiving time counting unit 188 for counting the receiving time of the good feeling display messages; and a new opposite sex member recommendation unit 189 by determining whether the good feeling display message is transmitted to the opponent member of the opposite sex by means of the good feeling display message obtainment unit 186 from the time of providing the detail personal information to the opponent member of the opposite sex in the detail personal information providing unit 185 to the designated time or not and then, recommending a new opposite sex member when the good feeling display message is not obtained within the appointed time; a member client 200 for executing the meeting arrangement application provided by the meeting arrangement server 100 or connecting to the website so as to provide the basic personal information, the profile information, and the current position information to the meeting arrangement server 100; and the access approving evaluation terminal 300 for acquiring the member information and the photo information provided by the arrangement server 100 and providing the approval evaluation pass information to the arrangement server 100.

The member client 200 may be a PC, a tablet, a smart phone, PDA etc. capable of using men or women. Also, it can include all devices capable of data communications through the communication network.

The meeting arrangement server 100 stores and manages the application program or the webpage information, to which member clients can be generally connected.

To be brief with the principles of the operation, it executes the meeting arrangement website or the meeting arrangement application and then, the meeting arrangement user signs up for a membership. At this time, the basic personal information (the residential area, the age, the job, the school, the contact address etc.) and the profile information as the additional information (his photograph, the character, the preference area, the ideal type etc.) are registered therein to join to be a member.

The access approving evaluation terminal 300 serves to acquire the member information and the photo information provided by the arrangement server 100 and provide the approval evaluation pass information to the arrangement server 100.

That is, where the approval evaluation is passed in the access approving evaluation terminal operated by the administrator based on the registered profile information, it can utilize the meeting arrangement matching. On the contrary, where the approval evaluation is not passed, the re-evaluation can be taken through the amendment of the profile.

At this time, the meeting arrangement server serves to match the meeting arrangement with the members more than one person among members of the opposite sex of passing the approving evaluation in order of matching success probability by considering the current residential area, the preference area, the age, the job, and the ideal type registered as the member information and the current connection position information.

The order of matching success probability can consider the personal information (the residential area, the preference area, the age, the ideal type, the religion, the older or the younger etc.), besides the current connection position information.

FIG. 2 is a block diagram illustrating a meeting arrangement server of a meeting arrangement system between members of a website and an application according to a preferred embodiment of the present invention.

The meeting arrangement server 100 includes a matching member registration unit 150 having a meeting arrangement application providing unit 151 for providing a meeting arrangement application to a member client 200; a member registration unit 152 for joining for a membership by acquiring a basic personal information and a profile information from the member client, which is equipped with the meeting arrangement application provided by the meeting arrangement application providing unit or connects to the website; an photo information registration unit 153 for extracting a photo information among the acquired profile information and storing it in a photo information DB; a member information registration unit 154 for storing the acquired basic personal information and profile information in a member information DB; the photo information database 155 for storing the photo information handled at the photo information registration unit therein; the member information database 156 for storing the basic personal information and profile information handled at the member information registration unit; an evaluation information transmission unit 157 for transmitting the information stored in the photo information database 155 and the member information database 156 to an access approving evaluation terminal; an approval evaluation pass information obtainment unit 158 for obtaining an approval evaluation pass information from the approving evaluation terminal; and a pass member information transmission unit 159 for transmitting the basic personal information and photo information of the member, who passes the approval evaluation, to the member matching unit.

The meeting arrangement application providing unit 151 serves to provide the meeting arrangement application to the member client 200.

At this time, as shown in FIG. 4, the member registration unit 152 serves to provide an input window so as to acquire the basic personal information and the profile information from the member clients having the meeting arrangement application provided by the meeting arrangement application providing unit or connecting to the website and join for a membership when the information is inputted to the corresponding input window.

The photo information registration unit 153 serves to extract the photo information among the acquired profile information and store it in the photo information database and the member information registration unit 154 serves to store the acquired basic personal information and profile information in the member information database.

The basic personal information means the E-mail, the nick name, the name, the date of birth, the cellular phone number, the blood type, the organization, the religion, the residence, the nationality, the preference region, the holding point, the holding item, the number of good feeling, the number of couple success, the charm index, and the message and the profile means the photo, the character, the appearance, the interest, the license information, and the job etc.

The evaluation information transmission unit 157 serves to transmit the information stored in the photo information database 155 and the member information database 156 to the access approving evaluation terminal and the approval evaluation pass information obtainment unit 158 serves to obtain the approval evaluation pass information from the approving evaluation terminal, so that the phrases called “Approval completion” is provided to the member client screen as shown in FIG. 4.

At this time, the pass member information transmission unit 159 serves to transmit the basic personal information and photo information of the member, who passes the approval evaluation, to the member matching unit, thereby completing the entire processing of the member matching.

Hereinafter, the member matching unit 180 will be described in detail.

That is, the member matching unit 180 includes a matching basic information storage processing unit 181 for acquiring the information transmitted from the pass member information transmission unit 159, extracting a sex, a residential area, a preference area, an age, and an ideal type information, and storing them in a matching basic information database; the matching basic information database 182 for storing the information handled at the matching basic information storage processing unit 181 therein; a current connection position extraction unit 183 for extracting a current connection position of the member stored in the matching basic information database 182; a matching member recommendation unit 184 for recommending female members to male members or male members to female members with reference to the information extracted from the matching basic information database 182 and the current connection position extraction unit 183; a detail personal information providing unit 185 for providing a detail personal information, which does not include a contact information of the opponent member of the opposite sex, to the member recommended by the matching member recommendation unit 184; a good feeling display message obtainment unit 186 for obtaining a good feeling display message from the client terminal of the member of the opposite sex; a contact information providing unit 187 for determining whether the good feeling display messages are generated by all members of the opposite sex through the good feeling display message obtainment unit 186 or not and providing the contact information of the opponent member of the opposite sex when the good feeling display messages are received from all members of the opposite sex; a message receiving time counting unit 188 for counting the receiving time of the good feeling display messages; and a new opposite sex member recommendation unit 189 by determining whether the good feeling display message is transmitted to the opponent member of the opposite sex by means of the good feeling display message obtainment unit 186 from the time of providing the detail personal information to the opponent member of the opposite sex in the detail personal information providing unit 185 to the designated time or not and then, recommending a new opposite sex member when the good feeling display message is not obtained within the appointed time.

That is, the matching basic information storage processing unit 181 serves to acquire the information transmitted from the pass member information transmission unit 159, extract the sex, the residential area, the preference area, the age, and the ideal type information, and store them in the matching basic information database.

Also, the current connection position extraction unit 183 serves to extract the current connection position of the member stored in the matching basic information database 182. In case of the website, the current connection position of the member is extracted through the tracking of the connected address. Also, In case of the application, the current connection position of the member is extracted through the tracking of the position thereof.

The matching member recommendation unit 184 serves to recommend the female members to the male members or the male members to the female members with reference to the information extracted from the matching basic information database 182 and the current connection position extraction unit 183.

That is, as shown in FIG. 5, since the connecting member is male, the profile information of the female member is provided thereto.

The detail personal information providing unit 185 serves to provide the detail personal information, which does not include the contact information of the opponent member of the opposite sex, to the member recommended by the matching member recommendation unit 184.

In the meantime, according to another embodiment of the present invention, the matching member recommendation unit 184 can recommend the members of the opposite sex by using only the matching basic information database 182.

Therefore, it can be matched through only the basic information irrespective of the extraction of the connection position thereof.

At this time, the good feeling display message obtainment unit 186 serves to obtain the good feeling display message from the client terminal of the member of the opposite sex, so that the good feeling is displayed on the good feeling expression icon as shown in FIG. 5.

Here, the contact information providing unit 187 serves to determine whether the good feeling display messages are generated by all members of the opposite sex through the good feeling display message obtainment unit 186 or not and provide the contact information of the opponent member of the opposite sex when the good feeling display messages are received from all members of the opposite sex.

At this time, the message receiving time counting unit 188 serves to count the receiving time of the good feeling display messages, so that the remaining time of the blind date is displayed thereon as shown in FIG. 5.

The new opposite sex member recommendation unit 189 serves to determine whether the good feeling display message is transmitted to the opponent member of the opposite sex by means of the good feeling display message obtainment unit 186 from the time of providing the detail personal information to the opponent member of the opposite sex in the detail personal information providing unit 185 to the designated time or not and then, recommend the new opposite sex member when the good feeling display message is not obtained within the appointed time.

In case of the recommendation of the new opposite sex member, it recommends the opposite sex member of the next ranking.

In the meantime, the meeting arrangement server 100 according to the additional embodiment of the present invention further includes an information sharing providing unit for providing a message or a chatting function to the matched male member and the matched female member so as to execute any program capable of sharing the real-time information with the matched members.

The matching member recommendation unit 184 does not again recommend the opposite sex member recommended in the past until the fixed period is passed or the new opposite sex member until the fixed recommendation count is exceeded.

That is, it does not again recommend the opposite sex member when the period established by the administrator is not passed or the new opposite sex member until the fixed recommendation count is exceeded.

The meeting arrangement server 100 further includes a scoring table providing unit for providing the scoring table for evaluating the good feeling as a score after the private personal information of the recommended opposite sex member is checked out.

That is, it provides a selection window capable of evaluating the good feeling as a score so as to refer to it during the calculation of rank.

The meeting arrangement server 100 further includes a good feeling score providing unit for providing a view of an individual good feeling score of the corresponding member assigned by the recommended opposite sex members, a view of a good feeling average score of the corresponding member assigned by the recommended opposite sex members, and an information for comparing the good feeling average score of the corresponding member with the good feeling average scores of the same sex members so as to utilize them as an objective index.

In the meantime, the matching member recommendation unit 184 includes a self recommendation module 184a for providing an information capable of selecting the opposite sex members whom the corresponding member wants to be recommended in case of recommending the opposite sex member and a member filtering module 184b for filtering upper members within the fixed higher rank in terms of the number of the good feeling expression and the good feeling score assigned by the opposite sex members in case of selecting the desiring opposite sex members whom the corresponding member wants to be recommended.

That is, the self recommendation module 184a serves to provide the information capable of selecting the opposite sex members whom the corresponding member wants to be recommended in case of recommending the opposite sex member. At this time, the member filtering module 184b serves to filter the upper members within the fixed higher rank in terms of the number of the good feeling expression and the good feeling score assigned by the opposite sex members in case of selecting the desiring opposite sex members whom the corresponding member wants to be recommended.

For example, if the member selects the desiring opposite sex members within the higher rank 20, it filters the upper members within the top 20 to be provided.

Also, the matching member recommendation unit 184 includes a celebrity selection module 184c for providing an information capable of selecting a celebrity in case of recommending the opposite sex member, and a look-alike recommendation module 184d for recognizing the photo of the registered opposite sex member with reference to the selected celebrity information and recommending the member of looking just like the corresponding celebrity. At this time, the celebrity selection module 184c serves to the information capable of selecting a celebrity in case of recommending the opposite sex member. Here, if the male member selects the entertainer “JEON, Ji-Hyun”, the look-alike recommendation module 184d serves to recognize the photo of the registered opposite sex member with reference to the selected celebrity information and recommend the member of looking just like the corresponding celebrity.

Since the picture recognition technology is already widely known to person skilled in the arts, the detailed explanation is omitted here.

The matching member recommendation unit 184 includes a charm member recommendation module 184e for recommending the members having high good feeling score and many number of the good feeling expression and the administrator selection VIP members in case of recommending the opposite sex member. It provides the charm members where the specific member purchases the specific item to be used. At this time, the member purchases the charm people connection ticket of FIG. 6 and uses this, so that it is provided.

The matching member recommendation unit 184 includes a public matching selection module 184f for providing an information for a public matching request in case of recommending the opposite sex member and a public recommendation module 184g for recommending the corresponding member to the entire opposite sex members in case of passing the examination of the access approving evaluation terminal when it acquires the public matching request information.

That is, if the member selects the public matching request, the public recommendation module 184g serves to recommend the corresponding member to the entire opposite sex members in case of passing the examination of the access approving evaluation terminal.

The member purchases the separate item ticket to be used, so that it can be executed.

Also, the matching member recommendation unit 184 includes a re-recommendation module 184h for recommending the past recommendation member list information, which does not match and connect thereto while recommending the new opposite sex member, where the designated time for the good feeling expression is passed. That is, as shown in FIG. 6, if it purchases the past relationship reconnecting ticket to be used, the recommendation module serves to recommend the past recommendation member list information, which does not match and connect thereto.

In case of using this, the screen of FIG. 8 is provided.

In the meantime, the contact information providing unit 187 according to the additional embodiment of the present invention includes an item providing unit (not shown) for providing items for performing the corresponding functions during the good feeling expression, the message and chatting progress, the good feeling score confirmation, the self recommendation, the look-alike recommendation, the public request, and the recommendation of the past recommendation figure.

That is, the item tickets capable of using during the good feeling expression, the good feeling score confirmation, and the recommendation request are provided to the corresponding member to be purchased, so that the number of the holding items is increased as shown in FIG. 4.

In the meantime, as shown in FIG. 7, a charm certificate window for confirming my charm certificate is provided to be purchased, so that it can check out the good feeling score of the corresponding member.

Also, the matching member recommendation unit 184 includes a specific language providing module 184i for providing a screen displayed as the language of the corresponding nation based on the location information thereof in case of connecting to the website or executing the application program and providing a screen displayed as the corresponding language in case of selecting the supportive language.

That is, it basically provides the language used in the corresponding nation based on the location information thereof and the screen displayed as the corresponding language in case of selecting the supportive language by means of the member so as to perform the language communication smoothly.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A meeting arrangement system between members of a website and an application comprising:
a meeting arrangement server 100 comprising a matching member registration unit 150 having a meeting arrangement application providing unit 151 for providing a meeting arrangement application to a member client 200, a member registration unit 152 for joining for a membership by acquiring a basic personal information and a profile information from the member client, which is equipped with the meeting arrangement application provided by the meeting arrangement application providing unit or connects to the website, an photo information registration unit 153 for extracting a photo information among the acquired profile information and storing it in a photo information DB; a member information registration unit 154 for storing the acquired basic personal information and profile information in a member information database, the photo information database 155 for storing the photo information handled at the photo information registration unit therein, the member information database 156 for storing the basic personal information and profile information handled at the member information registration unit; an evaluation information transmission unit 157 for transmitting the information stored in the photo information database 155 and the member information database 156 to an access approving evaluation terminal, an approval evaluation pass information obtainment unit 158 for obtaining an approval evaluation pass information from the access approving evaluation terminal, and a pass member information transmission unit 159 for transmitting the basic personal information and photo information of the member, who passes the approval evaluation, to the member matching unit; and the member matching unit 180 having a matching basic information storage processing unit 181 for acquiring the information transmitted from the pass member information transmission unit 159, extracting a sex, a residential area, a preference area, an age, and an ideal type information, and storing them in a matching basic information database, the matching basic information database 182 for storing the information handled at the matching basic information storage processing unit 181 therein, a current connection position extraction unit 183 for extracting a current connection position of the member stored in the matching basic information database 182, a matching member recommendation unit 184 for recommending female members to male members or male members to female members with reference to the information extracted from the matching basic information database 182 and the current connection position extraction unit 183, a detail personal information providing unit 185 for providing a detail personal information, which does not include a contact information of the opponent member of the opposite sex, to the member recommended by the matching member recommendation unit 184, a good feeling display message obtainment unit 186 for obtaining a good feeling display message from the client terminal of the member of the opposite sex, a contact information providing unit 187 for determining whether the good feeling display messages are generated by all members of the opposite sex through the good feeling display message obtainment unit 186 or not and providing the contact information of the opponent member of the opposite sex when the good feeling display messages are received from all members of the opposite sex, a message receiving time counting unit 188 for counting the receiving time of the good feeling display messages, and a new opposite sex member recommendation unit 189 by determining whether the good feeling display message is transmitted to the opponent member of the opposite sex by means of the good feeling display message obtainment unit 186 from the time of providing the detail personal information to the opponent member of the opposite sex in the detail personal information providing unit 185 to the designated time or not and then, recommending a new opposite sex member when the good feeling display message is not obtained within the appointed time;
a member client 200 for executing the meeting arrangement application provided by the meeting arrangement server 100 or connecting to the website so as to provide the basic personal information, the profile information, and the current position information to the meeting arrangement server 100; and
the access approving evaluation terminal 300 for acquiring the member information and the photo information provided by the arrangement server 100 and providing the approval evaluation pass information to the arrangement server 100, wherein the contact information providing unit 187 comprises an item providing unit (not shown) for providing items for performing the corresponding functions during the good feeling expression, the message and chatting progress, the good feeling score confirmation, the self recommendation, the look-alike recommendation, the public request, and the recommendation of the past recommendation figure.

2. The meeting arrangement system between members of a website and an application as claimed in claim 1, wherein the meeting arrangement server 100 further comprises an information sharing providing unit for providing a message or a chatting function to the matched male member and the matched female.

3. The meeting arrangement system between members of a website and an application as claimed in claim 1, wherein the matching member recommendation unit 184 recommends the opponent sex member with reference to a nationality, a residential nation, a residential area, a connection area, a preference area, a religion, an age, and an ideal type information in case of recommending the opposite sex member.

4. The meeting arrangement system between members of a website and an application as claimed in claim 1, wherein the matching member recommendation unit 184 does not again recommend the opposite sex member recommended in the past until the fixed period is passed or the new opposite sex member until the fixed recommendation count is exceeded in case of the recommendation of the new opposite sex member.

5. The meeting arrangement system between members of a website and an application as claimed in claim 1, wherein the meeting arrangement server 100 further comprises a scoring table providing unit for providing the scoring table for evaluating the good feeling as a score after the private personal information of the recommended opposite sex member is checked out.

6. The meeting arrangement system between members of a website and an application as claimed in claim 1, wherein the meeting arrangement server 100 further comprises a good feeling score providing unit for providing a view of an individual good feeling score of the corresponding member assigned by the recommended opposite sex members, a view of a good feeling average score of the corresponding member assigned by the recommended opposite sex members, and an information for comparing the good feeling average score of the corresponding member with the good feeling average scores of the same sex members.

7. The meeting arrangement system between members of a website and an application as claimed in claim 1, wherein the matching member recommendation unit 184 comprises a self recommendation module 184a for providing an information capable of selecting the opposite sex members whom the corresponding member wants to be recommended in case of recommending the opposite sex member and a member filtering module 184b for filtering upper members within the fixed higher rank in terms of the number of the good feeling expression and the good feeling score assigned by the opposite sex members in case of selecting the desiring opposite sex members whom the corresponding member wants to be recommended.

8. The meeting arrangement system between members of a website and an application as claimed in claim 1, wherein the matching member recommendation unit 184 comprises a public matching selection module 184f for providing an information for a public matching request in case of recommending the opposite sex member and a public recommendation module 184g for recommending the corresponding member to the entire opposite sex members in case of passing the examination of the access approving evaluation terminal when it acquires the public matching request information.

9. The meeting arrangement system between members of a website and an application as claimed in claim 1, wherein the matching member recommendation unit 184 comprises a re-recommendation module 184h for recommending the past recommendation member list information, which does not match and connect thereto while recommending the new opposite sex member, where the designated time for the good feeling expression is passed.

10. The meeting arrangement system between members of a website and an application as claimed in claim 1, wherein the matching member recommendation unit 184 comprises a specific language providing module 184i for providing a screen displayed as the language of the corresponding nation based on the location information thereof in case of connecting to the website or executing the application program and providing a screen displayed as the corresponding language in case of selecting the supportive language.

11. The meeting arrangement system between members of a website and an application as claimed in claim 1, wherein the matching member recommendation unit 184 recommends the members of the opposite sex by using only the matching basic information database.
